(19) United States
(12) Patent Application Publication
(10) Pub. No.: US 2023/0295781 A1
(43) Pub. Date: Sep. 21, 2023

(54) Cold rolled and annealed steel sheet and method of manufacturing the same

(71) Applicant: ArcelorMittal, Luxembourg (LU)

(72) Inventors: Astrid PERLADE, Le Ban-Saint-Martin (FR); Kangying ZHU, Metz (FR); Coralie JUNG, Metz (FR)

(21) Appl. No.: 18/016,595

(22) PCT Filed: Jul. 12, 2021
(86) PCT No.: PCT/IB2021/056237

§ 371 Date: Jan. 17, 2023

(30) Foreign Application Priority Data
Jul. 24, 2020 (WO) PCT/IB2020/056997

(51) Int. Cl. C22C 38/14; C22C 38/12; C22C 38/06; C22C 38/04; C22C 38/02; C22C 38/00; C21D 9/46; C21D 8/02; C21D 6/00; B32B 7/05; B32B 15/01

(52) U.S. Cl. CPC C22C 38/14; C22C 38/12; C22C 38/06; C22C 38/04; C22C 38/02; C22C 38/002; C22C 38/001; C21D 9/46; C21D 8/0205; C21D 6/005; C21D 6/008; C21D 8/0226; C21D 8/0236; C21D 8/0263; B32B 7/05; B32B 15/011; C21D 2211/001; C21D 2211/005; C21D 2211/008; B32B 2250/02; B32B 2311/30

(57) ABSTRACT

A cold rolled and annealed steel sheet, made of a steel having a composition including, by weight percent: C: 0.03-0.18%, Mn: 6.0-11.0%, Al: 0.2-3%, Mo: 0.05-0.5%, B: 0.0005-0.005%, S≤0.010%, P≤0.020%, N≤0.008%, and including optionally one or more of the following elements, in weight percentage: Si≤1.20%, Ti≤0.050%, Nb≤0.050%, Cr≤0.5%, V≤0.2%, the remainder of the composition being iron and unavoidable impurities resulting from the smelting, the steel sheet having a microstructure including, in surface fraction, from 25% to 55% of retained austenite, from 5% to 50% of ferrite, from 5 to 70% of partitioned martensite less than 5% of fresh martensite, a carbon [C]_{A} and manganese [Mn]_{A} content in austenite, expressed in weight percent, such that the ratio ([C]_{A}²×[Mn]_{A})/(C %²×Mn %) is from 3.0 to 8.0, C % and Mn % being the nominal values in carbon and manganese in weight % and an inhomogeneous repartition of manganese characterized by a manganese distribution with a slope above or equal to −40.

The present invention relates to a high strength steel sheet having good weldability properties and to a method to obtain such steel sheet.

### BACKGROUND

To manufacture various items such as parts of body structural members and body panels for automotive vehicles, it is known to use sheets made of DP (Dual Phase) steels or TRIP (Transformation Induced Plasticity) steels.

### SUMMARY OF THE INVENTION

One of the major challenges in the automotive industry is to decrease the weight of vehicles in order to improve their fuel efficiency in view of the global environmental conservation, without neglecting the safety requirements. To meet these requirements, new high strength steels are continuously developed by the steelmaking industry, to have sheets with improved yield and tensile strengths, and good ductility and formability.

One of the developments made to improve mechanical properties is to increase content of manganese in steels. The presence of manganese helps to increase ductility of steels thanks to the stabilization of austenite. But these steels present weaknesses of brittleness. To overcome this problem, elements as boron are added. These boron-added chemistries are very tough at the hot-rolled stage but the hot band is too hard to be further processed. The most efficient way to soften the hot band is batch annealing, but it leads to a loss of toughness.

In addition to these mechanical requirements, such steel sheets have to show a good resistance to liquid metal embrittlement (LME). Zinc or Zinc-alloy coated steel sheets are very effective for corrosion resistance and are thus widely used in the automotive industry. However, it has been experienced that arc or resistance welding of certain steels can cause the apparition of particular cracks due to a phenomenon called Liquid Metal Embrittlement (“LME”) or Liquid Metal Assisted Cracking (“LMAC”). This phenomenon is characterized by the penetration of liquid Zn along the grain boundaries of underlying steel substrate, under applied stresses or internal stresses resulting from restraint, thermal dilatation or phases transformations. It is known that adding elements like carbon or silicon are detrimental for LME resistance.

The automotive industry usually assesses such resistance by limiting the upper value of a so-called LME index calculated according to the following equation:

LME index=C %+Si %/4,
wherein C % and Si % stands respectively for the weight percentages of carbon and silicon in the steel.

The publication WO2020011638 relates to a method for providing a medium and intermediate manganese (Mn between 3.5 to 12%) cold-rolled steel with a reduced carbon content. Two process routes are described. The first one concerns an intercritical annealing of the cold rolled steel sheet. The second one concerns a double annealing of the cold rolled steel sheet, the first one being fully austenitic, the second one being intercritical. Thanks to the choice of the annealing temperature, a good compromise of tensile strength and elongation is obtained. By lowering annealing temperature an enrichment in austenite is obtained, which implies a good fracture thickness strain value. But the low amount of carbon and manganese used in the invention limits the tensile strength of the steel sheet to values not higher than 980 MPa.

An object of the present invention is to provide a cold rolled and annealed steel sheet having a combination of high mechanical properties with a tensile strength TS above or equal to 1000 MPa, a uniform elongation UE above or equal to 13% and a total elongation TE above or equal to 16%.

Preferably, the cold rolled and annealed steel sheet has a yield strength above or equal to 850 MPa.

Preferably, the cold rolled annealed steel sheet according to the invention satisfies YS×UE+TS×TE>31 000 MPa.%.

Preferably, the cold rolled annealed steel sheet according to the invention has a LME index of less than 0.36.

Preferably, the cold rolled and annealed steel sheet according to the invention has a carbon equivalent Ceq lower than 0.4%, the carbon equivalent being defined as

Ceq=C %+Si %/55+Cr %/20+Mn %/19−Al %/18+2.2P %−3.24B %−0.133*Mn %*Mo %
with elements being expressed by weight percent.

Preferably, the resistance spot weld of two steel parts of the cold rolled and annealed steel sheet according to the invention has an α value of at least 30 daN/mm².

The present invention provides a cold rolled and annealed steel sheet, made of a steel having a composition comprising, by weight percent:
C: 0.03-0.18%
Mn: 6.0-11.0%
Al: 0.2-3%
Mo: 0.05-0.5%
B: 0.0005-0.005%
S≤0.010%
P≤0.020%
N≤0.008%
and comprising optionally one or more of the following elements, in weight percentage:
Si≤1.20%
Ti≤0.050%
Nb≤0.050%
Cr≤0.5%
V≤0.2%
the remainder of the composition being iron and unavoidable impurities resulting from the smelting,
said steel sheet having a microstructure comprising, in surface fraction,
from 25% to 55% of retained austenite,
from 5% to 50% of ferrite,
from 5 to 70% of partitioned martensite
less than 5% of fresh martensite,
a carbon [C]_{A} and manganese [Mn]_{A} content in austenite, expressed in weight percent, such that the ratio ([C]_{A}²×[Mn]_{A})/(C %²×Mn %) is from 3.0 to 8.0, C % and Mn % being the nominal values in carbon and manganese in weight % and
an inhomogeneous repartition of manganese characterized by a manganese distribution with a slope above or equal to −40.

### BRIEF DESCRIPTION OF THE DRAWINGS

FIG. 1 represents a section of the hot rolled and heat-treated steel sheet of trial 4 and trial 15.

FIG. 2 shows the plotted curve for trial 4 and trial 15 of accumulated area fraction with respect to the Mn content.

### DETAILED DESCRIPTION

The invention will now be described in detail and illustrated by examples without introducing limitations.

According to the invention the carbon content is from 0.03% to 0.18% to ensure a satisfactory strength and good weldability properties. Above 0.18% of carbon, weldability of the steel sheet and the resistance to LME may be reduced. The temperature of the soaking depends on carbon content: the higher the carbon content, the lower the soaking temperature to stabilize austenite. If the carbon content is lower than 0.03%, the austenite fraction is not stabilized enough to obtain, after soaking, the desired tensile strength and elongation. In a preferred embodiment of the invention, the carbon content is from 0.05% to 0.15%. In another preferred embodiment of the invention, the carbon content is from 0.05% to 0.10%.

The manganese content is from 6.0% to 11.0%. Above 11.0% of addition, weldability of the steel sheet may be reduced, and the productivity of parts assembly can be reduced. Moreover, the risk of central segregation increases to the detriment of the mechanical properties. As the temperature of soaking depends on manganese content too, the minimum of manganese is defined to stabilize austenite, to obtain, after soaking, the targeted microstructure and strengths. Preferably, the manganese content is from 6.0% to 9%.

According to the invention, aluminium content is from 0.2% to 3% to decrease the manganese segregation during casting. Aluminium is a very effective element for deoxidizing the steel in the liquid phase during elaboration. Above 3% of addition, the weldability of the steel sheet may be reduced, so as cast ability. Moreover, tensile strength above 980 MPa is difficult to achieve. Moreover, the higher the aluminium content, the higher the soaking temperature to stabilize austenite. Aluminium is added at least 0.2% to improve product robustness by enlarging the intercritical range, and to improve weldability. Moreover, aluminium is added to avoid the occurrence of inclusions and oxidation problems. In a preferred embodiment of the invention, the aluminium content is from 0.7% to 2.2%.

The molybdenum content is from 0.05% to 0.5% to decrease the manganese segregation during casting. Moreover, an addition of at least 0.05% of molybdenum provides resistance to brittleness. Above 0.5%, the addition of molybdenum is costly and ineffective in view of the properties which are required. In a preferred embodiment of the invention, the molybdenum content is from 0.15% to 0.35%.

According to the invention, the boron content is from 0.0005% to 0.005% to improve the toughness of the hot rolled steel sheet and the spot weldability of the cold rolled steel sheet. Above 0.005%, the formation of boro-carbides at the prior austenite grain boundaries is promoted, making the steel more brittle. In a preferred embodiment of the invention, the boron content is from 0.001% to 0.003%.

Optionally some elements can be added to the composition of the steel according to the invention.

The maximum addition of silicon content is limited to 1.20% to improve LME resistance. In addition, this low silicon content makes it possible to simplify the process by eliminating the step of pickling the hot rolled steel sheet before the hot band annealing. Preferably the maximum silicon content added is 0.5%.

Titanium can be added up to 0.050% to provide precipitation strengthening. Preferably, a minimum of 0.010% of titanium is added in addition of boron to protect boron against the formation of BN.

Niobium can optionally be added up to 0.050% to refine the austenite grains during hot-rolling and to provide precipitation strengthening. Preferably, the minimum amount of niobium added is 0.010%.

Chromium and vanadium can optionally be respectively added up to 0.5% and 0.2% to provide improved strength.

The remainder of the composition of the steel is iron and impurities resulting from the smelting. In this respect, P, S and N at least are considered as residual elements which are unavoidable impurities. Their content is less than or equal to 0.010% for S, less than or equal to 0.020% for P and less than or equal to 0.008% for N.

The microstructure of the cold rolled and annealed steel sheet according to the invention will now be described. It contains, in surface fraction:
from 25% to 55% of retained austenite,
from 5% to 50% of ferrite,
from 5% to 70% of partitioned martensite
less than 5% of fresh martensite,
a carbon [C]_{A} and manganese [Mn]_{A} content in austenite, expressed in weight percent, such that the ratio ([C]_{A}²×[Mn]_{A})/(C %²×Mn %) is from 3.0 to 8.0, C % and Mn % being the nominal values in carbon and manganese in weight %, and
an inhomogeneous repartition of manganese characterized by a manganese distribution in the microstructure with a slope above or equal to −40.

The microstructure of the steel sheet according to the invention contains from 25% to 55% of retained austenite and preferably from 30 to 50% of austenite. Below 25% or above 55% of austenite, the uniform and total elongations UE and TE can not reach the respective minimum values of 13% and 16%.

Such austenite is formed during the intercritical annealing of the hot-rolled steel sheet but also during the first and second intercritical annealing of the cold rolled steel sheet. During the intercritical annealing of the hot rolled steel sheet, areas containing a manganese content higher than nominal value and areas containing a manganese content lower than nominal value are formed, creating a heterogeneous distribution of manganese. Carbon co-segregates with manganese accordingly. This manganese heterogeneity is measured thanks to the slope of manganese distribution for the hot rolled steel sheet, which must be above or equal to −30, as shown on FIG. 2 and explained later.

Thanks to the inhomogeneous repartition of manganese in austenite after the hot band annealing and the low diffusion kinetics of manganese in austenite, the manganese heterogeneity formed during hot band annealing is still present after the first and second intercritical annealing of the cold rolled steel sheet. This can be evidenced by the slope of manganese distribution in the microstructure which is above or equal to −40.

The carbon [C]_{A} and manganese [Mn]_{A} contents in austenite, expressed in weight percent, are such that the ratio ([C]_{A}²×[Mn]_{A})/(C %²×Mn %) is from 3.0 to 8.0. When the ratio is below 3.0, the retained austenite is not stable enough to provide a continuous TRIP-TWIP effect during deformation. When it is above 8.0, the retained austenite is too stable to generate a sufficient TRIP-TWIP effect during deformation. Such TWIP-TRIP effect is notably explained in “Observation-of-the-TWI P-TRI P-Plasticity-Enhancement-Mechanism-in-Al-Added-6-Wt-Pct-Medium-Mn-Steel”, DOI: 10.1007/s11661-015-2854-z, The Minerals, Metals & Materials Society and ASM International 2015, p. 2356 Volume 46A, June 2015 (S. LEE, K. LEE, and B. C. DE COOMAN).

The microstructure of the steel sheet according to the invention contains from 5 to 50% of ferrite, preferably from 10 to 45% of ferrite. Such ferrite is formed during the intercritical annealing of the hot-rolled steel sheet but also during the first and second intercritical annealing of the cold rolled steel sheet.

The microstructure of the steel sheet according to the invention contains from 5 to 70% of partitioned martensite, preferably from 8 to 50% of partitioned martensite. Such martensite can be formed upon cooling after the intercritical annealing of the hot-rolled steel sheet, by transformation of a part of austenite, that is less rich in carbon and martensite than the nominal values. But it is mostly formed upon cooling after the first annealing of the cold rolled steel sheet and then gets partitioned during the second annealing of the cold rolled steel sheet.

Fresh martensite can be present up to 5% in surface fraction but is not a phase that is desired in the microstructure of the steel sheet according to the invention. It can be formed during the final cooling step to room temperature by transformation of unstable austenite. Indeed, this unstable austenite with low carbon and manganese contents leads to a martensite start temperature Ms above 20° C. To obtain the final mechanical properties, the fresh martensite is limited to a maximum of 5% and preferably reduced down to 0%.

Partitioned martensite can be distinguished from fresh martensite on a section polished and etched with a reagent known per se, for example Nital reagent, observed by Scanning Electron Microscopy (SEM) or on a section polished, analysed by Electron Backscatter Diffraction (EBSD). Partitioned martensite has an average C content strictly lower than the nominal C content of the steel. This low C content results from the partitioning of carbon from the martensite, created upon quenching below the Ms temperature of the steel, to the austenite, during the holding at a partitioning temperature T_{P}.

By contrast, the fresh martensite, which results from the transformation of carbon enriched austenite into martensite after the partitioning step, has a C content higher than the nominal carbon content of the steel and a dislocation density higher than the partitioned martensite.

The cold rolled and annealed steel sheet according to the invention has a tensile strength TS above or equal to 1000 MPa, a uniform elongation UE above or equal to 13% and a total elongation TE above or equal to 16%.

Preferably, the cold rolled and annealed steel sheet has a yield strength above or equal to 850 MPa.

Preferably, the cold rolled and annealed steel sheet has a LME index below 0.36.

Preferably, the cold rolled and annealed steel sheet has a carbon equivalent Ceq lower than 0.4% in order to improve weldability. The carbon equivalent is defined as Ceq=C %+Si %/55+Cr %/20+Mn %/19−Al %/18+2.2P %−3.24B %−0.133*Mn %*Mo %, with elements being expressed by weight percent.

A welded assembly can be manufactured by producing two parts out of sheets of cold rolled and annealed steel according to the invention, and then perform resistance spot welding of the two steel parts.

The resistance spot welds joining the first sheet to the second sheet are characterized by a high resistance in cross-tensile test defined by an a value of at least 30 daN/mm².

The steel sheet according to the invention can be produced by any appropriate manufacturing method and the person skilled in the art can define one. It is however preferred to use the method according to the invention comprising the following steps:

A semi-product able to be further hot-rolled, is provided with the steel composition described above. The semi product is heated to a temperature from 1150° C. to 1300° C., so to make it possible to ease hot rolling, with a final hot rolling temperature FRT from 800° C. to 1000° C. Preferably, the FRT is from 850° C. to 950° C.

The hot-rolled steel is then cooled and coiled at a temperature Tam from 20° C. to 650° C., and preferably from 300 to 500° C.

The hot rolled steel sheet is then cooled to room temperature and can be pickled.

The hot rolled steel sheet is then annealed to an annealing temperature T_{HBA} between Ac1 and Ac3. More precisely, T_{HBA} is chosen to minimize the fraction of precipitated carbides below 0.8% and to promote manganese inhomogeneous repartition. This manganese heterogeneity is measured thanks to the slope of manganese distribution for the hot rolled steel sheet, which must be above or equal to −30. Preferably the temperature T_{HBA} is comprised from Ac1+5° C. to Ac3. Preferably the temperature T_{HBA} is from 580° C. to 680° C.

The steel sheet is maintained at said temperature T_{HBA} for a holding time t_{HBA} from 0.1 to 120h to promote manganese diffusion and formation of inhomogeneous manganese distribution. Moreover, this heat treatment of the hot rolled steel sheet allows decreasing the hardness while maintaining the toughness above 0.4 J/mm² of the hot-rolled steel sheet.

The hot rolled and heat-treated steel sheet is then cooled to room temperature and can be pickled to remove oxidation.

The hot rolled and heat-treated steel sheet is then cold rolled at a reduction rate from 20% to 80%.

The cold rolled steel sheet is then submitted to a first annealing at an intercritical temperature T1ₛₒₐₖ comprised between Ac1 and Ac3 of the cold rolled steel sheet for a holding time t1ₛₒₐₖ of 10s to 1800s. Ac1 and Ac3 are determined through dilatometry tests. T1ₛₒₐₖ and t1ₛₒₐₖ are selected to obtain 50% to 95% of austenite, in surface fraction, at the end of the soaking, which allows keeping the manganese heterogeneity formed during hot band annealing as much as possible. This is evidenced by the steel sheet showing a slope of manganese distribution in the microstructure of at least −40. Preferably, the intercritical temperature T1ₛₒₐₖ is from 650 to 850° C. and more preferably from 710° C. to 780° C. and the time t1ₛₒₐₖ is from 100 to 1000s. Such first annealing can be performed by continuous annealing.

Upon cooling, a fraction of austenite which is less rich in manganese and carbon will transform into fresh martensite. This fresh martensite will contain areas enriched in manganese and carbon and areas depleted in manganese and carbon.

Moreover, the microstructure will contain 5% to 50% of ferrite after the cooling following the first annealing.

The cold rolled steel sheet is then submitted to a second annealing at an intercritical temperature T2ₛₒₐₖ comprised between Ac1 and Ac3 of the annealed steel sheet for a holding time t2ₛₒₐₖ of 30s to 3600s. Ac1 and Ac3 are determined through dilatometry tests. Preferably, the intercritical temperature T2ₛₒₐₖ is from 550° C. to 650° C. and t2ₛₒₐₖ is from to 100 to 1500s.

The objective of this second annealing is to continue the partitioning of carbon and manganese in the austenite and in the martensite. Since the carbon and manganese in a part of the fresh martensite is higher than nominal, this part of martensite can transform into austenite at a lower temperature than T1ₛₒₐₖ, accompanied by the partition of manganese and carbon into such austenite. Another part of martensitic structure which is poorer in carbon and manganese will not transform into austenite but will lead to the partition of both carbon and manganese into austenite. Consequently, T2ₛₒₐₖ is lower than T1ₛₒₐₖ. t2ₛₒₐₖ is preferably longer than t1ₛₒₐₖ to let sufficient time for the diffusion of carbon in austenite, but should remain low enough to avoid that the final content of austenite is above 55% so that austenite will then be containing an insufficient amount of carbon to ensure the TRIP-TWIP effect.

Preferably the intercritical temperature T2ₛₒₐₖ is from 500° C. to 650° C. and the time t2ₛₒₐₖ is from 200 to 1000s. Such second annealing can be performed by continuous annealing.

The cold rolled and annealed steel sheet is then cooled below 80° C. and preferably to room temperature. Upon cooling, a fraction of austenite which is less rich in manganese and carbon may transform into fresh martensite.

The sheet can then be coated by any suitable process including hot-dip coating, electrodeposition or vacuum coating of zinc or zinc-based alloys or of aluminium or aluminium-based alloys.

The invention will be now illustrated by the following examples, which are by no way limitative.

### EXAMPLES

Four grades, whose compositions are gathered in table 1, were cast in semi-products and processed into steel sheets.

TABLE 1
Compositions

| | | | | | | | | | | | | | Ac1 | Ac3 |
|---|---|---|---|---|---|---|---|---|---|---|---|---|---|---|
| Steel | C | Mn | Al | Mo | B | S | P | N | Si | Nb | Ti | Ceq | (° C.) | (° C.) |
| A | 0.051 | 8.00 | 1.03 | 0.31 | 0.003 | 0.001 | 0.004 | 0.002 | 0.039 | 0.035 | 0.015 | 0.12 | 560 | 835 |
| B | 0.065 | 9.97 | 2.14 | 0.31 | 0.002 | 0.002 | 0.006 | 0.002 | 0.045 | 0.033 | 0.015 | 0.14 | 560 | 865 |
| C | 0.068 | 7.92 | 0.90 | 0.32 | 0.002 | 0.002 | 0.011 | 0.003 | 0 | 0.032 | 0.015 | 0.15 | 560 | 830 |
| D | 0.090 | 9.53 | 1.69 | 0.32 | 0.002 | 0.002 | 0.010 | 0.003 | 0 | 0.031 | 0.015 | 0.17 | 550 | 845 |

Ac1 and Ac3 temperatures of the cold rolled steel sheets have been determined through dilatometry tests and metallography analysis.

The tested compositions are gathered in the following table wherein the element contents are expressed in weight percent.

TABLE 2
Process parameters of the hot rolled and heat-treated steel sheets

| | | Hot rolling | Coiling | Hot band annealing (HBA) | |
|---|---|---|---|---|---|
| Trials | Steel | FRT (° C.) | CT (° C.) | T_{HBA}(° C.) | t_{HBA}(h) |
| 1 | A | 900 | 450 | 620 | 10 |
| 2 | A | 900 | 450 | 620 | 10 |
| 3 | A | 900 | 450 | 620 | 10 |
| 4 | A | 900 | 450 | — | — |
| 5 | A | 900 | 450 | — | — |
| 6 | A | 900 | 450 | — | — |
| 7 | B | 900 | 450 | 620 | 10 |
| 8 | B | 900 | 450 | 620 | 10 |
| 9 | B | 900 | 450 | 620 | 10 |
| 10 | B | 900 | 450 | 620 | 10 |
| 11 | B | 900 | 450 | 620 | 10 |
| 12 | B | 900 | 450 | 620 | 10 |
| 13 | B | 900 | 450 | 620 | 10 |
| 14 | B | 900 | 450 | 620 | 10 |
| 15 | C | 900 | 450 | 640 | 10 |
| 16 | C | 900 | 450 | 640 | 10 |
| 17 | C | 900 | 450 | 640 | 10 |
| 18 | C | 900 | 450 | 640 | 10 |
| 19 | C | 900 | 450 | 640 | 10 |
| 20 | C | 800 | 450 | 640 | 10 |
| 21 | C | 800 | 450 | 640 | 10 |
| 22 | D | 900 | 450 | 640 | 10 |
| 23 | D | 900 | 450 | 640 | 10 |

Underlined values: parameters which do not allow to obtain the targeted properties

Steel semi-products, as cast, were reheated at 1200° C., hot rolled and then coiled at 450° C. The hot rolled and coiled steel sheets are then heat treated at a temperature T_{HBA} and maintained at said temperature for a holding time t_{HBA}. The following specific conditions to obtain the hot rolled and heat-treated steel sheets were applied:

The hot rolled and heat-treated steel sheets were analyzed, and the corresponding properties are gathered in table 3.

TABLE 3
Microstructure and properties of the hot
rolled and heat-treated steel sheet

| | Slope of the Mn | Fraction of precipitated |
|---|---|---|
| Trials | distribution | carbides <0.8% |
| 1 | −16 | OK |
| 2 | −16 | OK |
| 3 | −16 | OK |
| 4 | −68 | OK |
| 5 | −68 | OK |
| 6 | −68 | OK |
| 7 | −16 | OK |
| 8 | −16 | OK |
| 9 | −16 | OK |
| 10 | −16 | OK |
| 11 | −16 | OK |
| 12 | −16 | OK |
| 13 | −16 | OK |
| 14 | −16 | OK |
| 15 | −13 | OK |
| 16 | −13 | OK |
| 17 | −13 | OK |
| 18 | −13 | OK |
| 19 | −13 | OK |
| 20 | −13 | OK |
| 21 | −13 | OK |
| 22 | −12 | OK |
| 23 | −12 | OK |

Underlined values: do not match the targeted values.

The slope of the manganese distribution and the fraction of precipitated carbides were determined.

The fraction of precipitated carbides is determined thanks to a section of sheet examined through Scanning Electron Microscope with a Field Emission Gun (“FEG-SEM”) and image analysis at a magnification greater than 15000×.

The heat treatment of the hot rolled steel sheet allows manganese to diffuse in austenite: the repartition of manganese is heterogeneous with areas with low manganese content and areas with high manganese content. This manganese heterogeneity helps to achieve mechanical properties and can be measured thanks to manganese profile.

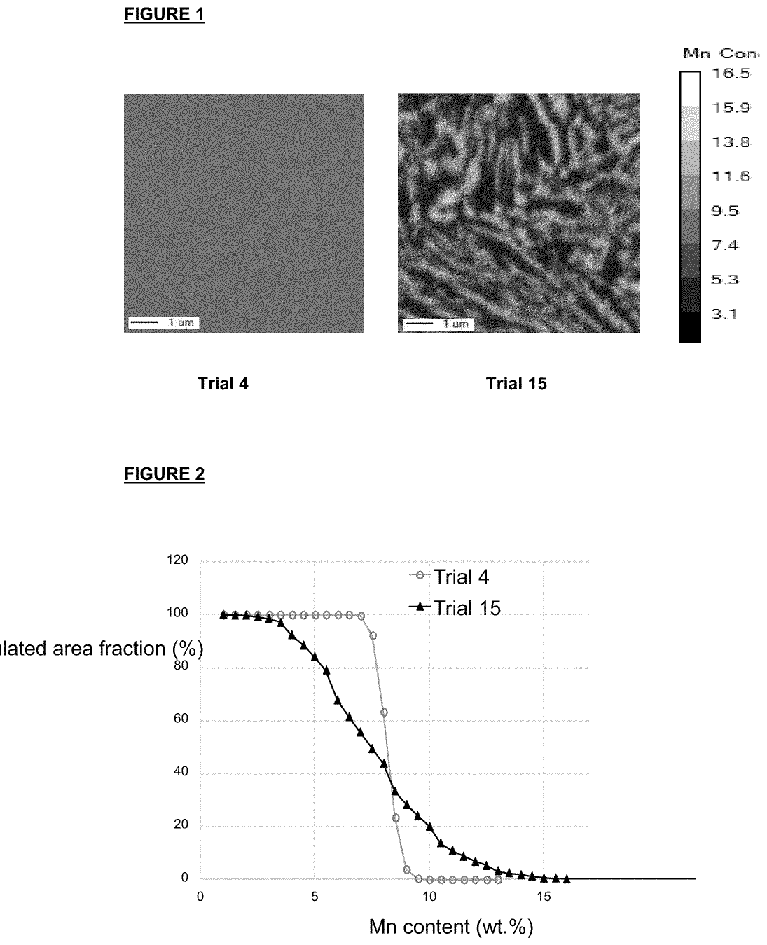

FIG. 1 represents a section of the hot rolled and heat-treated steel sheet of trial 4 and trial 15. The black area corresponds to area with lower amount of manganese, the grey area corresponds to a higher amount of manganese.

This figure is obtained through the following method: a specimen is cut at ¼ thickness from the hot rolled and heat-treated steel sheet and polished.

The section is afterwards characterized through electron probe micro-analyzer, with a Field Emission Gun (“FEG”) at a magnification greater than 10000× to determine the manganese amounts. Three maps of 10 μm*10 μm of different parts of the section were acquired. These maps are composed of pixels of 0.01 μm². Manganese amount in weight percent is calculated in each pixel and is then plotted on a curve representing the accumulated area fraction of the three maps as a function of the manganese amount.

This curve is plotted in FIG. 2 for trial 4 and trial 15: 100% of the sheet section contains more than 1% of manganese. For trial 15, 20% of the sheet section contains more than 10% of manganese.

The slope of the curve obtained is then calculated between the point representing 80% of accumulated area fraction and the point representing 20% of accumulated area fraction.

For trial 4, the absence of heat treatment after hot rolling implies that the repartition of manganese is not heterogeneous enough, which can be seen by the value of the slope of the manganese distribution lower than −30. This is also the case for trials 5 and 6.

On the contrary, for trial 15, the repartition of manganese is clearly non-homogenous, which is evidenced by the value of the slope of the manganese distribution higher than −30. This is also the case for all other trials except 4 to 6.

TABLE 4
Process parameters of the cold rolled and annealed steel sheets

| | Cold rolling | First annealing | | Second annealing | |
|---|---|---|---|---|---|
| Trials | (%) | T1ₛₒₐₖ(° C.) | t1ₛₒₐₖ(s) | T2ₛₒₐₖ(° C.) | t2ₛₒₐₖ(s) |
| 1 | 50 | 725 | 200 | 550 | 900 |
| 2 | 50 | 750 | 200 | 550 | 500 |
| 3 | 50 | 750 | 200 | 550 | 900 |
| 4 | 50 | 725 | 600 | 550 | 900 |
| 5 | 50 | 725 | 600 | 520 | 900 |
| 6 | 50 | 750 | 350 | 550 | 900 |
| 7 | 50 | 725 | 200 | 550 | 900 |
| 8 | 50 | 750 | 200 | 550 | 500 |
| 9 | 50 | 750 | 200 | 550 | 900 |
| 10 | 50 | 710 | 500 | 540 | 900 |
| 11 | 50 | 725 | 200 | 520 | 900 |
| 12 | 50 | 725 | 500 | 520 | 900 |
| 13 | 50 | 725 | 500 | 500 | 900 |
| 14 | 50 | 750 | 500 | 520 | 900 |
| 15 | 50 | 720 | 100 | 550 | 250 |
| 16 | 50 | 720 | 300 | 550 | 500 |
| 17 | 50 | 720 | 300 | 550 | 900 |
| 18 | 50 | 750 | 300 | 575 | 900 |
| 19 | 50 | 750 | 300 | 590 | 900 |
| 20 | 50 | 750 | 120 | 640 | 300 |
| 21 | 50 | 780 | 120 | 640 | 300 |
| 22 | 50 | 750 | 300 | 525 | 900 |
| 23 | 50 | 770 | 100 | 575 | 900 |

Underlined values: parameters which do not allow to obtain the targeted properties

The hot rolled and heat-treated steel sheet obtained are then cold rolled. The cold rolled steel sheet are then first annealed at a temperature T1ₛₒₐₖ and maintained at said temperature for a holding time t1ₛₒₐₖ, before being cooled below 80° C. The steel sheet is then annealed a second time at a temperature T2ₛₒₐₖ and maintained at said temperature for a holding time t2ₛₒₐₖ, before being cooled to room temperature. The following specific conditions to obtain the cold rolled and annealed steel sheets were applied:

The cold rolled and annealed sheets were then analyzed, and the corresponding microstructure elements, mechanical properties and weldability properties were respectively gathered in table 5, 6 and 7.

TABLE 5
Microstructure of the cold rolled and annealed steel sheet

| | | | | | | | Slope of the Mn | |
|---|---|---|---|---|---|---|---|---|
| | Retained | | Partitioned | | | | distribution | |
| | austenite | Ferrite | Martensite | [C]_{A} | [Mn]_{A} | [C]_{A}² × [Mn]_{A}/ | after 1st | after 2nd |
| Trials | (%) | (%) | (%) | (% wt) | (% wt) | C %² × Mn % | annealing | annealing |
| 1 | 34 | 50 | 16 | 0.11 | 10.4 | 6.0 | −17 | −17 |
| 2 | 18 | 25 | 57 | 0.15 | 10.8 | 11.7 | −18 | −18 |
| 3 | 32 | 25 | 43 | 0.11 | 10.5 | 6.1 | −18 | −18 |
| 4 | 19 | 35 | 46 | 0.15 | 8.6 | 9.3 | −52 | −50 |
| 5 | 16 | 35 | 49 | 0.17 | 8.7 | 12.1 | −52 | −51 |
| 6 | 18 | 20 | 62 | 0.15 | 8.8 | 9.5 | −60 | −55 |
| 7 | 50 | 42 | 8 | 0.11 | 11.7 | 3.4 | −17 | −17 |
| 8 | 45 | 35 | 20 | 0.11 | 11.7 | 3.4 | −18 | −18 |
| 9 | 59 | 35 | 6 | 0.09 | 11.1 | 2.1 | −18 | −18 |
| 10 | 58 | 40 | 2 | 0.09 | 11.1 | 2.1 | −16 | −17 |
| 11 | 58 | 42 | 0 | 0.09 | 11.2 | 2.2 | −17 | −17 |
| 12 | 57 | 38 | 5 | 0.09 | 11.0 | 2.1 | −17 | −18 |
| 13 | 52 | 38 | 10 | 0.10 | 11.0 | 2.6 | −17 | −18 |
| 14 | 39 | 28 | 33 | 0.10 | 10.8 | 2.6 | −19 | −19 |
| 15 | 40 | 50 | 10 | 0.13 | 10.4 | 4.8 | −14 | −14 |
| 16 | 42 | 44 | 14 | 0.13 | 10.4 | 4.8 | −14 | −15 |
| 17 | 45 | 44 | 11 | 0.12 | 10.3 | 4.1 | −14 | −14 |
| 18 | 24 | 30 | 46 | 0.18 | 10.3 | 9.1 | −16 | −17 |
| 19 | 31 | 30 | 39 | 0.15 | 10.0 | 6.1 | −16 | −17 |
| 20 | 40 | 38 | 22 | 0.13 | 10.4 | 4.8 | −15 | −18 |
| 21 | 41 | 15 | 44 | 0.12 | 9.9 | 3.9 | −17 | −20 |
| 22 | 40 | 38 | 22 | 0.17 | 11.6 | 4.3 | −16 | −16 |
| 23 | 50 | 35 | 15 | 0.15 | 11.7 | 3.4 | −16 | −16 |

Underlined values: not corresponding to the invention

The phase percentages of the microstructures of the obtained cold rolled and annealed steel sheet and the slopes of the manganese distribution after the first annealing and after the second annealing were determined.

The surface fractions of phases in the microstructure are determined through the following method: a specimen is cut from the cold rolled and annealed steel sheet, polished and etched with a reagent known per se, to reveal the microstructure. The section is afterwards examined through scanning electron microscope, for example with a Scanning Electron Microscope with a Field Emission Gun (“FEG-SEM”) at a magnification greater than 5000×, in secondary electron mode.

The determination of the surface fraction of ferrite is performed thanks to SEM observations after Nital or Picral/Nital reagent etching.

The determination of the volume fraction of retained austenite is performed thanks to X-ray diffraction.

[C]A and [Mn]A corresponds to the amount of carbon and manganese in austenite, in weight percent. They are measured with both X-rays diffraction (C %) and electron probe micro-analyzer, with a Field Emission Gun (Mn %).

The heterogeneity of the manganese distribution obtained after the annealing of the hot rolled steel sheet is maintained as much as possible after both annealing steps of the cold rolled steel sheets. It can be seen by comparing slopes of the manganese distribution obtained after annealing of the hot rolled steel sheet (in Table 3) and the slope of the manganese distribution obtained after first and second annealing steps of the cold rolled steel sheet (Table 5).

TABLE 6
Mechanical properties of the cold rolled and annealed steel sheet

| | TS | UE | TE | YS | YS × UE + TS × TE |
|---|---|---|---|---|---|
| Trials | (MPa) | (%) | (%) | (MPa) | (MPa. %) |
| 1 | 1116 | 13.2 | 16.7 | 979 | 31560 |
| 2 | 1071 | 6.9 | 6.9 | 1071 | 14666 |
| 3 | 1114 | 13.6 | 17.7 | 998 | 33282 |
| 4 | 1155 | 8.7 | 11.1 | 1105 | 22317 |
| 5 | 1157 | 9.9 | 12.1 | 1106 | 24883 |
| 6 | 1133 | 1.3 | 5.9 | 1122 | 8084 |
| 7 | 1126 | 15.0 | 18.2 | 933 | 34442 |
| 8 | 1137 | 13.6 | 16.7 | 898 | 31129 |
| 9 | 1169 | 11.1 | 13.8 | 713 | 24047 |
| 10 | 1126 | 11.0 | 12.8 | 735 | 22456 |
| 11 | 1168 | 11.9 | 14.5 | 750 | 25861 |
| 12 | 1187 | 11.2 | 13.2 | 562 | 21923 |
| 13 | 1181 | 10.3 | 12.4 | 576 | 20572 |
| 14 | 1240 | 6.3 | 8.5 | 701 | 14890 |
| 15 | 1184 | 14.2 | 17.3 | 958 | 34071 |
| 16 | 1146 | 14.8 | 17.9 | 997 | 35210 |
| 17 | 1127 | 16.1 | 19.2 | 1040 | 38274 |
| 18 | 1052 | 8.1 | 8.1 | 1052 | 16937 |
| 19 | 1026 | 17.6 | 17.6 | 1026 | 36013 |
| 20 | 1096 | 20.8 | 24.7 | 978 | 47391 |
| 21 | 1040 | 20.9 | 26.2 | 978 | 47613 |
| 22 | 1162 | 14.6 | 18.1 | 1057 | 36448 |
| 23 | 1111 | 15.3 | 19.3 | 1061 | 37605 |

Underlined values: do not match the targeted values

Mechanical properties of the obtained cold rolled and annealed were determined and gathered in the following table.

The yield strength YS, the tensile strength TS and the total and uniform elongation TE, UE are measured according to ISO standard ISO 6892-1, published in October 2009.

Trial 2 was submitted to a second annealing which duration is too low to form enough austenite. On the contrary, t2ₛₒₐₖ of trial 3 is high enough.

Trials 9 and 10 were submitted to a second annealing which duration is too high so that too much austenite is formed with an insufficient amount of carbon, meaning that such austenite will not be stable enough. On the contrary, t2ₛₒₐₖ of trial 8 was low enough.

Trials 11 and 12 were submitted to a second annealing which temperature is too high and which duration is too high as well, so that too much austenite with an insufficient amount of carbon is formed.

Trials 13 and 14 were submitted to a second annealing which duration was too long so that the carbon content of austenite is too low.

Trial 18 was submitted to a second annealing which temperature was too low to form enough austenite. On the contrary, T2ₛₒₐₖ of trial 19 was high enough.

TABLE 7
Weldability properties of the cold rolled and annealed steel sheet

| Trials | α (daN/mm²) | LME index |
|---|---|---|
| 1 | 60 | 0.061 |
| 2 | 60 | 0.061 |
| 3 | 60 | 0.061 |
| 4 | 60 | 0.061 |
| 5 | 60 | 0.061 |
| 6 | 60 | 0.061 |
| 7 | 68 | 0.077 |
| 8 | 68 | 0.077 |
| 9 | 68 | 0.077 |
| 10 | 68 | 0.077 |
| 11 | 68 | 0.077 |
| 12 | 68 | 0.077 |
| 13 | 68 | 0.077 |
| 14 | 68 | 0.077 |
| 15 | 60 | 0.068 |
| 16 | 60 | 0.068 |
| 17 | 60 | 0.068 |
| 18 | 60 | 0.068 |
| 19 | 60 | 0.068 |
| 20 | 60 | 0.068 |
| 21 | 60 | 0.068 |
| 22 | 63 | 0.090 |
| 23 | 63 | 0.090 |

LME index = C% + Si%/4, in wt %.

Spot welding in standard ISO 18278-2 condition was done on the cold rolled and annealed steel sheets.

In the test used, the samples are composed of two sheets of steel in the form of cross welded equivalent. A force is applied so as to break the weld point. This force, known as cross tensile Strength (CTS), is expressed in daN. It depends on the diameter of the weld point and the thickness of the metal, that is to say the thickness of the steel and the metallic coating. It makes it possible to calculate the coefficient α which is the ratio of the value of CTS on the product of the diameter of the welded point multiplied by the thickness of the substrate. This coefficient is expressed in daN/mm².

Weldability properties of the obtained cold rolled and annealed were determined and gathered in the following table:

What is claimed is:

1-11. (canceled)

12: A cold rolled and annealed steel sheet, made of a steel having a composition comprising, by weight percent:
C: 0.03-0.18%
Mn: 6.0-11.0%
Al: 0.2-3%
Mo: 0.05-0.5%
B: 0.0005-0.005%
S≤0.010%
P≤0.020%
N≤0.008%
and optionally one or more of the following elements:
Si≤1.20%
Ti≤0.050%
Nb≤0.050%
Cr≤0.5%
V≤0.2%
a remainder of the composition being iron and unavoidable impurities resulting from processing,
the steel sheet having a microstructure comprising, in surface fraction, from 25% to 55% of retained austenite, from 5% to 50% of ferrite, from 5 to 70% of partitioned martensite, less than 5% of fresh martensite, a carbon [C]_{A} and manganese [Mn]_{A} content in austenite, expressed in weight percent, such that the ratio ([C]_{A}²×[Mn]_{A})/(C %²×Mn %) is from 3.0 to 8.0, C % and Mn % being the nominal values in carbon and manganese in weight %, and an inhomogeneous repartition of manganese defined by a manganese distribution with a slope above or equal to −40.

13: The cold rolled and annealed steel sheet as recited in claim 12 wherein the carbon content is from 0.05% to 0.15%.

14: The cold rolled and annealed steel sheet as recited in claim 12 wherein wherein the manganese content is from 6.0% to 9%.

15: The cold rolled and annealed steel sheet as recited in claim 12 wherein the aluminium content is from 0.7% to 2.2%.

16: The cold rolled and annealed steel sheet as recited in claim 12 wherein the microstructure comprises from 30% to 50% of retained austenite,
from 5% to 40% of ferrite, from 8% to 50% of partitioned martensite.

17: The cold rolled and annealed steel sheet as recited in claim 12 wherein the tensile strength is above or equal to 1000 MPa, the uniform elongation UE is above or equal to 13% and the total elongation TE is above or equal to 16%.

18: The cold rolled and annealed steel sheet as recited in claim 12 wherein the yield strength is above or equal to 850 MPa.

19: The cold rolled and annealed steel sheet as recited in claim 12 wherein YS, UE, TS and TE satisfy the following equation:
YS×UE+TS×TE>31 000 MPa.%

20: The cold rolled and annealed steel sheet as recited in claim 12 wherein the LME index is below 0.36.

21: The cold rolled and annealed steel sheet as recited in claim 12 wherein the steel has a carbon equivalent Ceq lower than 0.4%, the carbon equivalent being defined as
Ceq=C %+Si %/55+Cr %/20+Mn %/19−Al %/18+2.2P %−3.24B %−0.133×Mn %×Mo %
with elements being expressed by weight percent.

22: A resistance spot weld of two steel parts made of the cold rolled and annealed steel sheet as recited in claim 12, the resistance spot weld having an α value of at least 30 daN/mm².
